(19) United States
(12) Patent Application Publication
(10) Pub. No.: US 2014/0168976 A1
(43) Pub. Date: Jun. 19, 2014

(54) LIGHTING APPARATUS

(71) Applicant: YADENT CO., LTD, Taipei City (TW)

(72) Inventor: Isamu OKI, Tainan City (TW)

(73) Assignee: YADENT CO., LTD., Taipei City (TW)

(21) Appl. No.: 14/187,922

(22) Filed: Feb. 24, 2014

Related U.S. Application Data
(63) Continuation-in-part of application No. 13/433,472, filed on Mar. 29, 2012, now Pat. No. 8,702,279.

(51) Int. Cl. F21V 29/00; F21V 21/00

(52) U.S. Cl. CPC F21V 29/22; F21V 21/00
USPC 362/249.01

(57) ABSTRACT

A lighting apparatus includes a bulb-shaped cover, a heat sink unit disposed in an interior space of the bulb-shaped cover and including an end wall portion having a lateral surface and a tubular portion, and a light-emitting unit including a first circuit board disposed on the end wall portion, a second circuit board disposed around the tubular portion, a third circuit board including at least one extension which covers the lateral surface, and a plurality of light-emitting elements respectively mounted on the first and second circuit boards and the extension of the third circuit board. A tubular seat is coupled to the bulb-shaped cover. An electrical connector is coupled to the tubular seat.

### CROSS-REFERENCE TO RELATED APPLICATION

This application is a continuation-in-part (CIP) of U.S. patent application Ser. No. 13/433,472, filed by the applicant on Mar. 29, 2012, the entire disclosure of which is incorporated herein by reference.

### BACKGROUND OF THE INVENTION

1. Field of the Invention

The invention relates to a lighting apparatus, more particularly to a lighting apparatus with enhanced heat dissipation ability.

2. Description of the Related Art

Light-emitting diodes (LEDs) have advantages of high luminance, energy-saving, etc., and belong to solid-state illuminations. Thus, there is a growing trend for the LEDs to serve as lighting apparatuses. In the case of replacing a conventional lamp (such as a tungsten bulb) using a LED lighting apparatus, a sufficient number of the LEDs should be provided in the LED lighting apparatus to have luminance comparable to the conventional lamp. However, if the heat generated by the LEDs in the LED lighting apparatus is not dissipated efficiently, light degradation may occur due to overheating of the LEDs. As such, the LED lighting apparatus may have a shorter service life.

Accordingly, in order to provide a LED lighting apparatus with improved heat dissipation, the applicant of this invention proposed a LED bulb, as disclosed in U.S. Patent Application Publication No. 20110273072, in which a plurality of LEDs are mounted to a circuit board, and a heat sink is in close contact with the circuit board opposite to the LEDs. With the heat sink, the heat generated by the LEDs can be transferred outwardly through a screw base of the LED bulb.

However, the applicant of this invention found that the heat dissipation problem is likely to occur in a small volume LED bulb (such as one having an E17-type screw base), even if the small volume LED bulb is provided with the aforesaid heat sink. This is because in order to have sufficient luminance, the LEDs in the small volume bulb are arranged in a relatively high density. In addition, since the volume of space inside the LED bulb is relatively small, the heat-exchanging area for the heat sink may be insufficient so that the heat energy generated by the LEDs may not be efficiently transferred to the screw base of the LED bulb through the heat sink, thereby resulting in an increase in the temperature of the LEDs that may shorten the service life of the LED bulb.

### SUMMARY OF THE INVENTION

Therefore, the object of the present invention is to provide a lighting apparatus that can overcome at least one of the aforesaid drawbacks associated with the prior art.

According to the present invention, a lighting apparatus comprises a bulb-shaped cover, a heat sink unit, a light-emitting unit, a tubular seat and an electrical connector. The bulb-shaped cover has an open end and a closed end opposite to the open end, and defines an interior space between the open and closed ends. The heat sink unit is disposed in the interior space, and includes an end wall portion and a first tubular portion. The end wall portion is disposed in proximity to the closed end of the bulb-shaped cover and has a first surface facing toward the closed end, a second surface opposite to the first surface, and a lateral surface interconnecting the first and second surfaces. The first tubular portion has a first end abutting against the second surface of the end wall portion, and a second end opposite to the first end and proximate to the open end of the bulb-shaped cover. The light-emitting unit is disposed on the heat sink unit and includes a first circuit board disposed on the first surface of the end wall portion, a second circuit board disposed around the first tubular portion, a third circuit board including at least one extension corresponding to the lateral surface of the end wall portion, and a plurality of light-emitting elements respectively mounted on the first and second circuit boards and the extension of the third circuit board. The tubular seat is coupled to the open end of the bulb-shaped cover. The electrical connector is coupled to the tubular seat for connection with an external power source.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is an exploded perspective view of the first preferred embodiment of a lighting apparatus according to the present invention, but without a bulb-shaped cover;

FIG. 2 is an exploded sectional view of the first preferred embodiment of the lighting apparatus according to the present invention, but with the bulb-shaped cover;

FIG. 3 is an enlarged assembled sectional view of FIG. 2;

FIG. 4 is a front sectional view of the first preferred embodiment taken along line IV-IV of FIG. 3;

FIG. 5 is an exploded perspective view of the second preferred embodiment of a lighting apparatus according to the present invention, but without a bulb-shaped cover;

FIG. 6 is an enlarged fragmentary perspective view of FIG. 5 in an assembled state; and

FIG. 7 is an enlarged assembled sectional view of FIG. 5, but with the presence of the bulb-shaped cover;

FIG. 8 is an exploded perspective view of a portion of a lighting apparatus according to the third preferred embodiment of the present invention;

FIG. 9 is an enlarged fragmentary sectional view of the third preferred embodiment in an assembled state;

FIG. 10 is an exploded perspective view of a portion of a lighting apparatus according to the fourth preferred embodiment of the present invention; and

FIG. 11 is an assembled front sectional view of the fourth preferred embodiment.

### DETAILED DESCRIPTION OF THE PREFERRED EMBODIMENTS

Before the present invention is described in greater detail with reference to the accompanying embodiments, it should be noted herein that like elements are denoted by the same reference numerals throughout the disclosure.

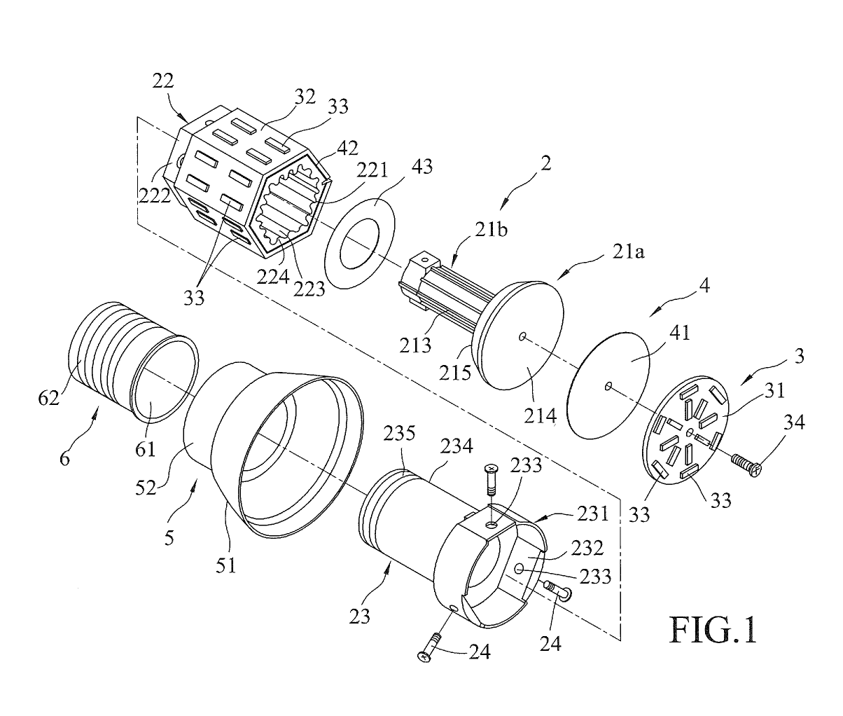

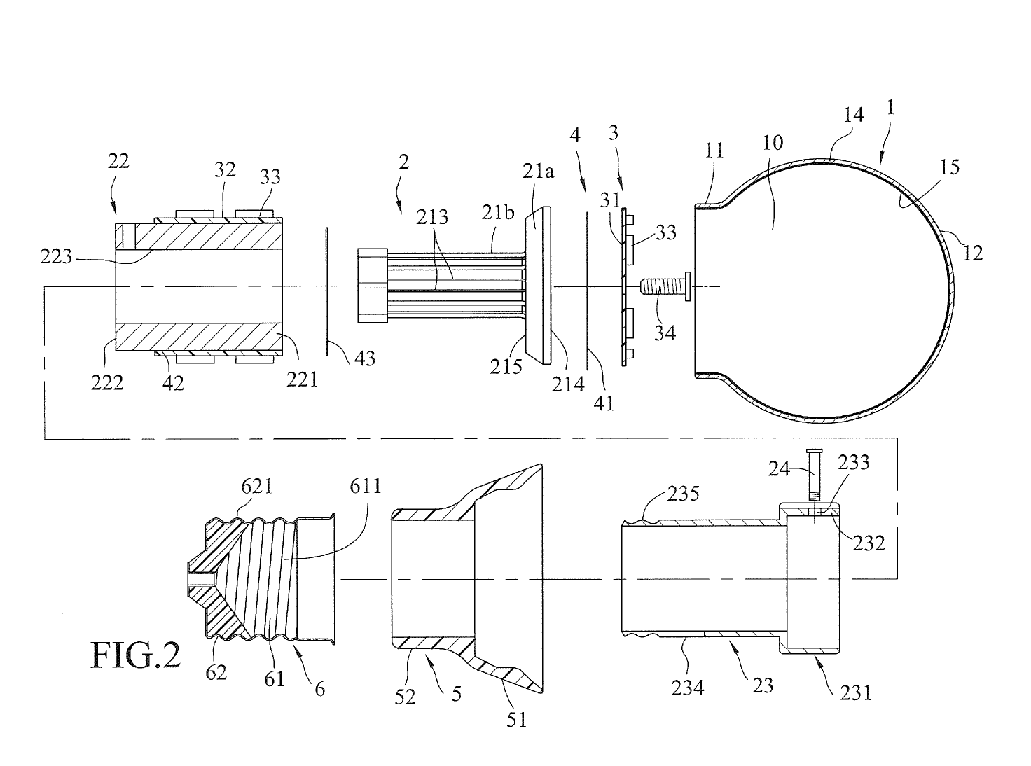

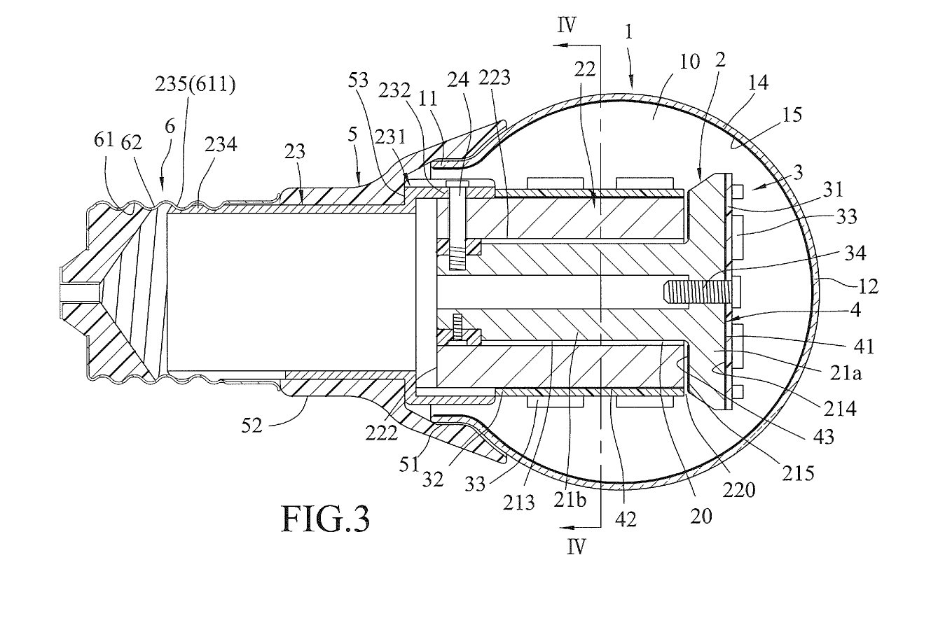

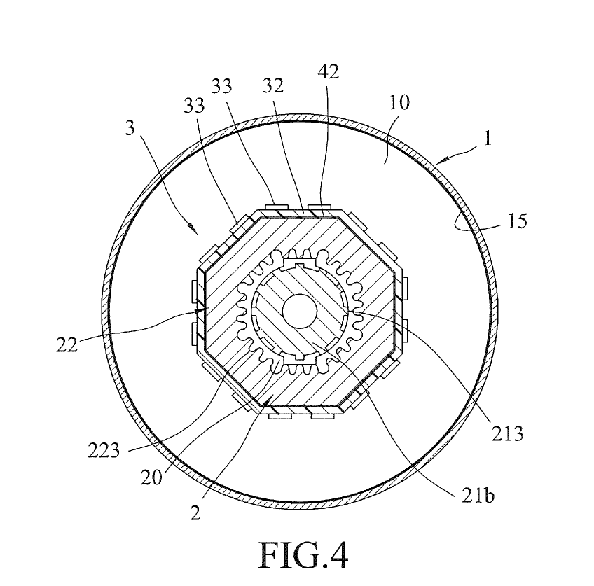

Referring to FIGS. 1-4, the first preferred embodiment of a lighting apparatus according to the present invention comprises a bulb-shaped cover 1, a heat sink unit 2, a light-emitting unit 3, a heat insulating unit 4, a tubular seat 5, and an electrical connector 6.

The bulb-shaped cover 1 has an open end 11 and a closed end 12 opposite to the open end 11, and defines an interior space 10 between the open and closed ends 11, 12. The bulb-shaped cover 1 can be made of glass, and has a shape similar to that of a conventional tungsten bulb.

The heat sink unit 2 is disposed in the interior space 10, and includes an end wall portion 21a, a hollow shank portion 21b, and first and second tubular portions 22, 23.

The end wall portion 21a has two opposite first and second surfaces 214, 215, and is disposed in proximity to the closed end 12. The first surface 214 faces toward the closed end 12, while the second surface 215 faces toward the open end 11.

The shank portion 21b is connected to and extends from the second surface 215 of the end wall portion 21a. In this embodiment, the shank portion 21b and the end wall portion 21a are formed in one piece, and the shank portion 21b has an outer surface formed with a plurality of protrusions 213 that are angularly spaced apart from each other.

The first tubular portion 22 has a hexagonal cylinder shape in this embodiment. Alternatively, the first tubular portion 22 may have other polygonal shapes or a circular cylinder shape. The first tubular portion 22 has opposite first and second ends 221, 222, and surrounds the shank portion 21b such that the first end 221 is disposed adjacent to the end wall portion 21a and the second end 222 is disposed adjacent to the open end 11 of the bulb-shaped cover 1. The first tubular portion 22 and the shank portion 21b define a heat-dissipating space 20 therebetween.

The first tubular portion 22 further has an inner surface that is formed with a plurality of troughs 223 and ridges 224, and that faces the outer surface of the shank portion 21b. By virtue of the protrusions 213 of the shank portion 21b, and the troughs 223 and the ridges 224 of the first tubular portion 22, a heat dissipation area of the heat sink unit 2 is increased, thereby enhancing heat dissipation efficiency of the heat sink unit 2.

The second tubular portion 23 has two opposite first and second open end sections 231, 234. The first open end section 231 surrounds the second end 222 of the first tubular portion 22. Specifically, the second end 222 of the first tubular portion 22 is fitted into the first open end section 231 such that at least a part of an outer surface of the first tubular portion 22 is in contact with an inner surface of the second tubular portion 23. Additionally, the second open end section 234 of the second tubular portion 23 has an outer thread 235.

In this embodiment, the elements of the heat sink unit 2 are fastened to each other using three fastening members 24. Each of the fastening members 24 is configured as a screw, and penetrates the first and second tubular portions 22, 23, and extends into the shank portion 21b to fasten together the shank portion 21b and the first and second tubular portions 22, 23.

To be more precise, the inner surface of the second tubular portion 23 is formed with three angularly spaced-apart flat face parts 232 at the first open end section 231, and three of six outer surface sections of the outer surface of the hexagonal first tubular portion 22 at the second end 222 thereof are respectively in contact with the three flat face parts 232. Accordingly, heat can be transmitted through the first and second tubular portions 22, 23. Each of the flat face parts 232 has a screw hole 233 for extension of a respective one of the fastening members 24.

In other embodiments, the elements of the heat sink unit 2 [i.e., the end wall portion 21a, the shank portion 21b, and the first and second tubular portions 22, 23] may be made of aluminum and may be formed in one piece in order to obtain the heat sink unit 2 with superior heat conduction effect.

The light-emitting unit 3 is disposed on the heat sink unit 2, and includes a first circuit board 31 disposed on the first surface 214 of the end wall portion 21a and facing toward the closed end 12 of the bulb-shaped cover 1, a second circuit board 32 disposed around the outer surface of the first tubular portion 22, and a plurality of light-emitting elements 33 respectively mounted on the first and second circuit boards 31, 32. In this embodiment, the first circuit board 31 is a rigid printed circuit board, and is secured to the first surface 214 using a screw 34. The second circuit board 32 is a flexible printed circuit board, and is bent to extend around the outer surface of the first tubular portion 22. The light-emitting elements 33 are light-emitting diodes. The light-emitting elements 33, which are mounted on the first circuit board 31, face toward the closed end 12 of the bulb-shaped cover 1 to emit light forwardly. The light-emitting elements 33, which are mounted on the second circuit board 32 to surround the first tubular portion 22, are disposed between the open end 11 and the closed end 12 of the bulb-shaped cover to emit light radially. Accordingly, the lighting apparatus of this invention can provide wide-angle illumination.

Further, an inner surface 14 of the bulb-shaped cover 1 is coated with a fluorescent coating 15 that can be excited by the light from the light-emitting elements 33. Light from the fluorescent coating 15 and light from the light-emitting elements 33 are different in color, and can be mixed together to produce white light that is close to natural light and that has excellent color rendering properties. For example, when the light emitted from the light-emitting members 33 is blue light and the fluorescent coating 15 can be excited by the blue light to emit yellow light, the blue light and the yellow light can be mixed together to produce white light.

In addition, the light-emitting unit 3 may further include other electronic components (not shown) to electrically connect to the electrical connector 6 (i.e., a screw base of a bulb), such as an AC/DC converting circuit, electrical wires, etc. Since these electronic components are well-known in the art, detailed descriptions of the same are omitted herein for the sake of brevity.

The heat insulating unit 4 is disposed at at least one of a position between the first surface 214 of the end wall portion 21a and the first circuit board 31, and a position between the first tubular portion 22 and the second circuit board 32. In this embodiment, the heat insulating unit 4 includes first, second, and third heat insulators 41, 42 and 43. The first heat insulator 41 is disposed between the first surface 214 of the end wall portion 21a and the first circuit board 31. The second heat insulator 42 is disposed between the first tubular portion 22 and the second circuit board 32. The third heat insulator 43 is disposed on the second surface 215 of the end wall portion 21a, and is spaced apart from the first end 221 of the first tubular portion 22 to define a gap 220 therebetween. The gap 220 is in spatial communication with both of the heat-dissipating space 20 and the interior space 10. Therefore, heat generated by the light-emitting unit 3 is dissipated through the heat-dissipating space 20 to the interior space 10 of the bulb-shaped cover 1 via the gap 220, and out into ambient air. In addition, through the presence of the third heat insulator 43 and the gap 220, the second surface 215 of the end wall portion 21a is thermally-insulated from the first tubular portion 22. Thus, the heat dissipated through the gap 220 is unlikely to be transferred to the end wall portion 21a.

Each of the first, second and third heat insulators 41, 42 and 43 is preferably made from a material having a relatively high heat resistance and a relatively low thermal conductivity, such as polyimide (PI). In this embodiment, each of the first, second and third heat insulators 41, 42 and 43 is a PI film having adhesivity. Therefore, the first, second and third heat insulators 41, 42 and 43 can be directly and respectively adhered to the first surface 214 of the end wall portion 21a, the outer surface of the first tubular portion 22, and the second surface 215 of the end wall portion 21a. By such arrangement of the heat insulating unit 4, the first and second circuit boards 31, 32 do not contact directly the heat sink unit 2. Of course, the heat insulating unit 4 may be made from other suitable materials.

The tubular seat 5 includes a trumpet-shaped portion 51, a tube portion 52, and an annular shoulder 53 connected between the trumpet-shaped portion 51 and the tube portion 52. The trumpet-shaped portion 51 is connected to and surrounds the open end 11 of the bulb-shaped cover 1. The tube portion 52 extends integrally from the trumpet-shaped portion 51 away from the bulb-shaped cover 1.

The electrical connector 6 is tubular, and has an open end, an inner wall 61 formed with an inner thread 611, and an outer wall 62 formed with an outer thread 621 for coupling threadedly with an electrical socket (not shown). Through the electrical socket, power from an external source can be transmitted to the electrical connector 6, and from the electrical connector 6 to the light emitting elements 33 for light emission. The second tubular portion 23 extends through the trumpet-shaped portion 51, the tube portion 52 and the open end of the electrical connector 6 to engage the outer thread 235 with the inner thread 611 of the electrical connector 6. At this time, the first open end section 231 of the second tubular portion 23 is seated on the annular shoulder 53 of the tubular seat 5, and the tubular seat 5 is positioned between the second tubular portion 23 and the electrical connector 6. Because the electrical connector 6 and the second tubular portion 23 of the heat sink unit 2 are threadedly connected to each other, heat can be transferred from the heat sink unit 2 to the electrical connector 6.

It should be noted that the second tubular portion 23 of the heat sink unit 2 and the electrical connector 6 can be interconnected using any other possible manner, such as pressfitting, and is not limited to the aforesaid disclosure.

With the lighting apparatus of this invention, heat generated by the light-emitting unit 3 can be dissipated in the manner described hereinbelow.

Heat generated by the light-emitting elements 33 mounted on the first circuit board 31 is transferred to the end wall portion 21a through the first circuit board and the first heat insulator 41, and is further transferred to the shank portion 21b. Since the shank portion 21b is in thermal contact with the second tubular portion 23, the heat is further transferred to the second tubular portion 23.

Similarly, heat generated from the light-emitting elements 33 mounted on the second circuit board 32 is transferred to the first tubular portion 22 through the second circuit board 32 and the second heat insulator 42. Since the first tubular portion 22 is in thermal contact with the second tubular portion 23, the heat is further transferred to the second tubular portion 23.

The heat transferred to the second tubular portion 23 is further transferred to the electrical connector 6, and then dissipated externally via the electrical connector 6.

Moreover, heat may also be dissipated to the ambient air through the heat-dissipating space 20 and the interior space 10 of the bulb-shaped cover 1 via the gap 220.

It should be noted that, although the heat insulating unit 4 has a relatively low thermal conductivity as stated above, heat may also be transferred through the heat insulating unit 4 when two opposite sides of each of the first, second and third heat insulators 41, 42 and 43 of the heat insulating unit 4 have a large temperature difference. Therefore, heat generated by the light-emitting elements 33 and then transferred to the first and second circuit boards 31, 32 may be further transferred to the end wall portion 21a and the first tubular portion 22 through the respective first and second heat insulators 41, 42 after the lighting apparatus of this invention is turned on for a short period of time. This is because after a short period of time, the temperatures of the light-emitting elements 33 and the first and second circuit boards 31, 32 are raised to be much higher than those of the end wall portion 21a and the first tubular portion 22.

On the other hand, after the lighting apparatus of this invention is turned on for a long period of time, the temperature difference between the two sides of each of the first, second and third heat insulators 41, 42 and 43 of the heat insulating unit 4 is greatly reduced because the heat generated by the light-emitting elements 33 is continuously transferred to the end wall portion 21a and the first tubular portion 22 through the first and second circuit boards 31, 32, and the first and second heat insulators 41, 42. At this time, by virtue of the first and second heat insulators 41, 42, heat energy accumulated in the end wall portion 21a and the first tubular portion 22 is likely to be transferred to the second tubular portion 23 and dissipated through the heat-dissipating space 20, and is unlikely to be transmitted to the first and the second circuit boards 31, 32. Therefore, even if the lighting apparatus is small-sized, and the surface area of the heat sink unit 2 is insufficient for efficient heat-dissipation, retardation of the heat-dissipation can be prevented.

Moreover, since the end wall portion 21a is thermally-insulated from the first tubular portion 22 by virtue of the gap 220 and the third heat insulator 43, the heat generated by the light-emitting elements 33 mounted on the second circuit board 32 and then dissipated to the ambient air via the gap 220 is not likely to be transferred to the light-emitting elements 33 mounted on the first circuit board 31 through the end wall portion 21a.

By virtue of the heat insulating unit 4 and the heat sink unit 2 of the lighting apparatus of this invention, heat-dissipation of the heat sink unit 2 can be enhanced, thereby prolonging the service life of the light-emitting unit 3.

In the following Table 1, the lighting apparatus of this invention with the heat insulating unit 4 serves as “Example”, and the conventional lighting apparatus without the heat insulating unit serves as “Comparative Example”. The “initial value” means the temperature measured directly after the lighting apparatus was turned on. The temperatures respectively measured after the lighting apparatus was turned on for 10, 20, 30 and 40 minutes are shown in Table 1.

Besides, the term “LEDs on A side” means the junction temperature between the first circuit board 31 and the light-emitting elements 33 mounted thereon, while the term “LEDs on B side” means the junction temperature between the second circuit board 32 and the light-emitting elements 33 mounted thereon.

TABLE 1

| | | Temperature measured after | | | | |
|---|---|---|---|---|---|---|
| | | the lighting apparatus was turned on | | | | |
| | | Initial | | | | |
| | | value | 10 min. | 20 min. | 30 min. | 40 min. |
| | | (° C.) | (° C.) | (° C.) | (° C.) | (° C.) |
| Example | LEDs on | 22.4 | 72.3 | 87.5 | 89.7 | 90.3 |
| | A side | | | | | |
| | LEDs on | 26.4 | 77 | 89 | 92 | 92 |
| | B side | | | | | |
| | Air in | 22.5 | 50 | 57 | 58 | 58 |
| | the | | | | | |
| | bulb- | | | | | |
| | shaped | | | | | |
| | cover | | | | | |
| Comparative | LEDs on | 22.4 | 91.9 | 107.5 | 110.2 | 111.3 |
| Example | A side | | | | | |
| | LEDs on | 26.4 | 84 | 97 | 102 | 103 |
| | B side | | | | | |
| | Air in | 22.5 | 56.7 | 65.4 | 65.9 | 66.9 |
| | the | | | | | |
| | bulb- | | | | | |
| | shaped | | | | | |
| | cover | | | | | |

As shown in Table 1, in the Comparative Example, the temperature of the light-emitting elements was approximately increased by 60° C. to 70° C. within 10 minutes after the lighting apparatus was turned on. In the Example, the temperature of the light-emitting elements was approximately increased by 50° C. Besides, after the lighting apparatus was turned on for 40 minutes, all of the temperatures measured in the Example of this invention are much lower than those measured in the Comparative Example.

With the heat insulating unit 4 disposed between the heat sink unit 2 and the light-emitting unit 3 to facilitate heat-dissipating effect of the heat sink unit 2, the lighting apparatus of this invention may have enhanced heat-dissipating ability, even if the lighting apparatus is small-sized and has insufficient heat-exchanging area. Thus, the light-emitting unit 3 may be prevented from overheating, thereby prolonging the service life of the lighting apparatus of this invention.

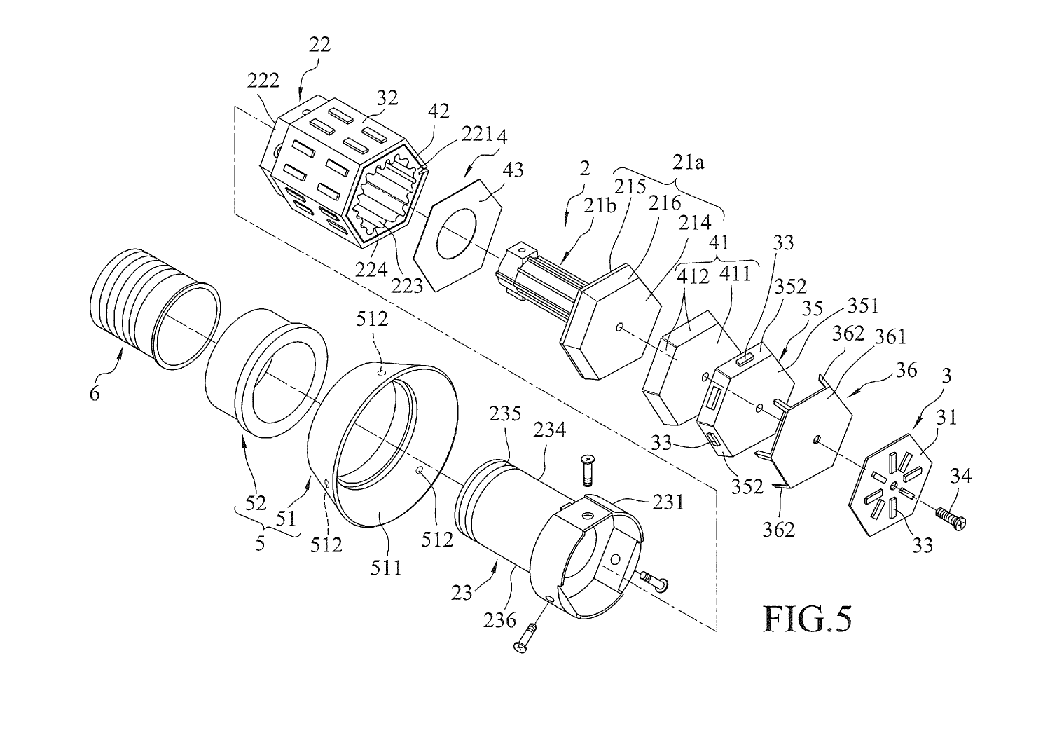

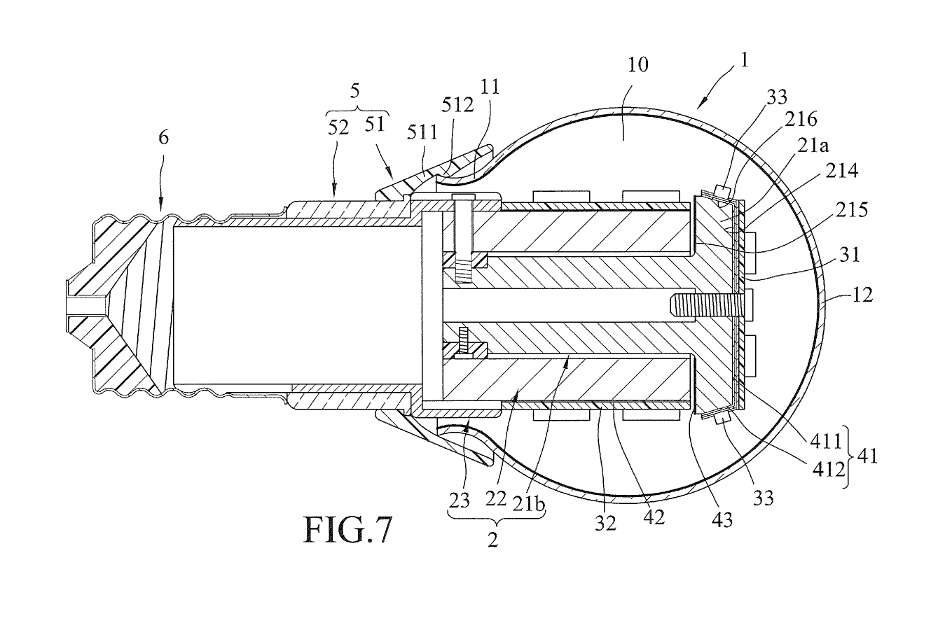

Referring to FIGS. 5-7, the second preferred embodiment of a lighting apparatus according to the present invention comprises a bulb-shaped cover 1, a heat sink unit 2, a light-emitting unit 3, a heat insulating unit 4, a tubular seat 5, and an electrical connector 6. The second preferred embodiment differs from the first preferred embodiment in the structures of the end wall portion 21a, the light-emitting unit 3, the first heat insulator 41 and the tubular seat 5.

In this embodiment, the end wall portion 21a further has a lateral surface 216 that interconnects the first and second surfaces 214, 215 and that is flared from a periphery of the first surface 214 toward a periphery of the second surface 215.

The light-emitting unit 3 further includes a third circuit board 35 disposed between the first heat insulator 41 and the first circuit board 31, and a fixing plate 36 disposed between the third circuit board 35 and the first circuit board 31. The third circuit board 35 is a flexible printed circuit board and includes a main board 351 disposed corresponding to the first surface 214 of the end wall portion 21a, and a plurality of extensions 352 extending transversely from a periphery of the main board 351 toward the first heat insulator 41. In this embodiment, the light-emitting elements 33 are respectively mounted on the first and second circuit boards 31, 32 and the extensions 352 of the third circuit board 35. The fixing plate 36 is made of aluminum, and has a base plate 361 covering the main board 351 of the third circuit board 35, and a plurality of spaced-apart claws 362 extending transversely from a periphery of the base plate 361 toward the third circuit board 35 to press the extensions 352 of the third circuit board 35 toward the lateral surface 216 of the end wall portion 21a. Preferably, each of the claws 362 presses against a junction of each two adjacent ones of the extensions 352. Actually, the fixing plate 36 is a planar plate with the base plate 361 and the claws 362 lying in the same plane. The claws 362 are bent relative to the base plate 361 during assembly.

In this embodiment, the extensions 352 of the flexible third circuit board 35 are also bent from the main board 351. Because the third circuit board 35 is flexible, the extensions 352 cannot be easily fixed at a bent position. Thus, by mounting the metallic fixing plate 36 to the third circuit board 35, the extensions 352 can be pressed by the claws 362 to stay in a bent position. Although a plurality of the claws 362 and a plurality of the extensions 352 are used in this embodiment, in actual application, only one claw 362 and one extension 352 may be used. Further, the extensions 352 may be secured in the bent position by using other means, such as adhesive. In this case, the fixing plate 36 can be omitted.

The first heat insulator 41 includes a planar part 411 and an edge part 412. The planar part 411 is disposed between the first surface 214 of the end wall portion 21a and the main board 351 of the third circuit board 35. The edge part 412 extends annularly from a periphery of the planar part 411 and is disposed between the lateral surface 216 of the end wall portion 21a and the extensions 352 of the third circuit board 35. That is, the extensions 352 cover the edge part 412. Thus, in this embodiment, the third circuit board 35 is thermally insulated from the end wall portion 21a by virtue of the first heat insulator 41.

The second open end section 234 of the second tubular portion 23 further has a non-threaded part 236 between the first open end section 231 and the outer thread 235.

In this embodiment, the trumpet-shaped portion 51 is made of a plastic material, and includes a surrounding wall 511 that is tapered from one end which is proximate to the bulb-shaped cover 1 toward another end which is proximate to the tube portion 52 to surround the open end of the bulb-shaped cover 1, and three angularly spaced-apart protrusions 512 protruding from an inner face of the surrounding wall 511 to engage with an outer surface of the bulb-shaped cover 1 in proximity to the open end 11. The trumpet-shaped portion 51 is preferably made of an elastic plastic material, so that the protrusions 512 can abut and press tightly against the outer surface of the bulb-shaped cover 1, thereby positioning the bulb-shaped cover 1 on the surrounding wall 511. Further, the open end 11 of the bulb-shaped cover 1 can also be adhered to the tubular seat 5 by using an adhesive. If the size of the trumped-shaped portion 51 is small, the trumpet-shaped portion 51 may be heated to soften and expand the same to facilitate engagement with the open end 11 of the bulb-shaped cover 1.

The tube portion 52 is made of a ceramic material and is disposed between the trumpet-shaped portion 51 and the electrical connector 6. The tube portion 52 is connected to the another end of the surrounding wall 511, and surrounds and contacts the non-threaded part 236 of the second tubular portion 23. The tube portion 52 has a certain level of air permeability since it is made of a ceramic material, such as calcined clay.

After the lighting apparatus of this invention is turned off, an air temperature inside the bulb-shaped cover 1 will decrease to the room temperature, thereby increasing the humidity inside the bulb-shaped cover 1. With the tube portion 52 being made of a ceramic material which is a porous material, moisture inside the bulb-shaped cover 1 can be discharged. Moreover, the tube portion 52 has a better thermal conductivity as compared to the plastic material so that it can assist in heat dissipation.

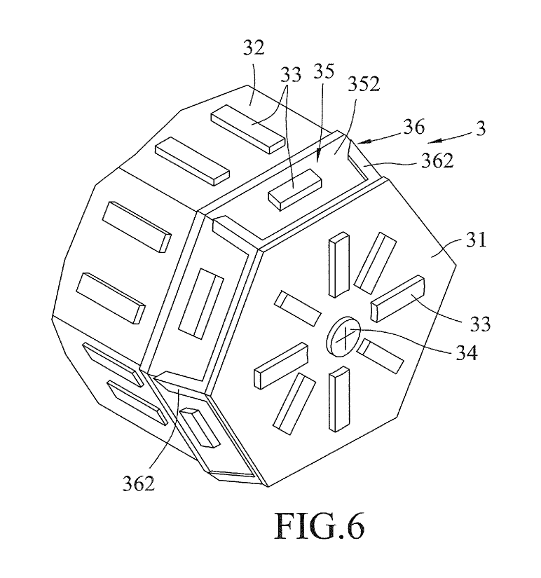

In this embodiment, as best shown in FIG. 6, the light-emitting elements 33 on the third circuit board 35 emit light at an angle different from that of the light-emitting elements 33 on the first and second circuit boards 31, 32. Accordingly, the lighting apparatus of the second embodiment of this invention can provide a wider illumination than that of the first embodiment.

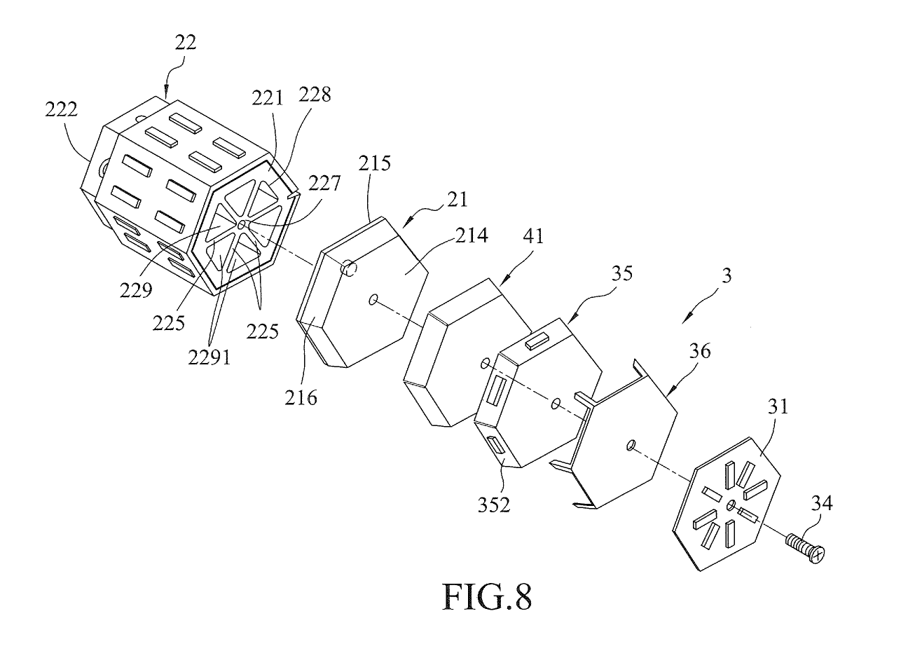

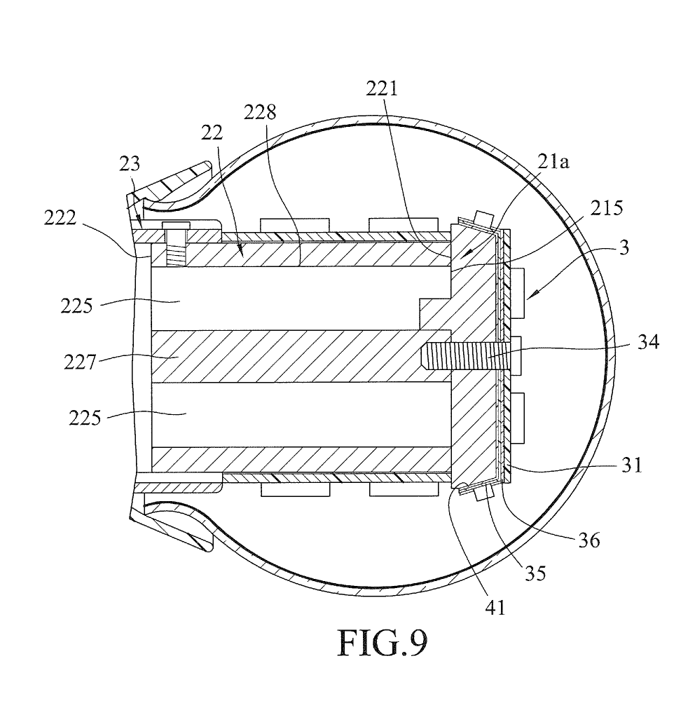

Referring to FIGS. 8 and 9, the third preferred embodiment of a lighting apparatus according to the present invention is similar to that of the second preferred embodiment. However, in this embodiment, the heat sink unit 2 does not include the shank portion 21b (see FIG. 5), and the third heat insulator 43 (see FIG. 5) is omitted.

In this embodiment, the first tubular portion 22 further has an inner periphery 228 defining a receiving space 229, a central rod 227 disposed in the receiving space 229, a plurality of angularly spaced-apart radial plates 225 connected between the inner periphery 228 and the central rod 227 and extending in an axial direction of the first tubular portion 22 to divide the receiving space 229 into a plurality of insert channels 2291.

As shown in FIG. 9, a screw 34 penetrates through the first circuit board 31, the fixing plate 36, the third circuit board 35, the first heat insulator 41 and the end wall portion 21a, and engages the central rod 227 of the first tubular portion 22 so as to fasten together the first circuit board 31, the fixing plate 36, the third circuit board 35, the first heat insulator 41, the end wall portion 21a and the first tubular portion 22. Further, the second surface 215 of the end wall portion 21a abuts against the first end 221 of the first tubular portion 22. Accordingly, heat generated by the light-emitting unit 3 can be transferred from the end wall portion 21a to the first tubular portion 22. Because the second tubular portion 23 is connected to the second end 222 of the first tubular portion 22 during assembly, heat from the first tubular portion 22 can be further transferred to the second tubular portion 23. The heat transferred to the second tubular portion 23 can be further transferred to the electrical connector 6, and then dissipated externally via the electrical connector 6.

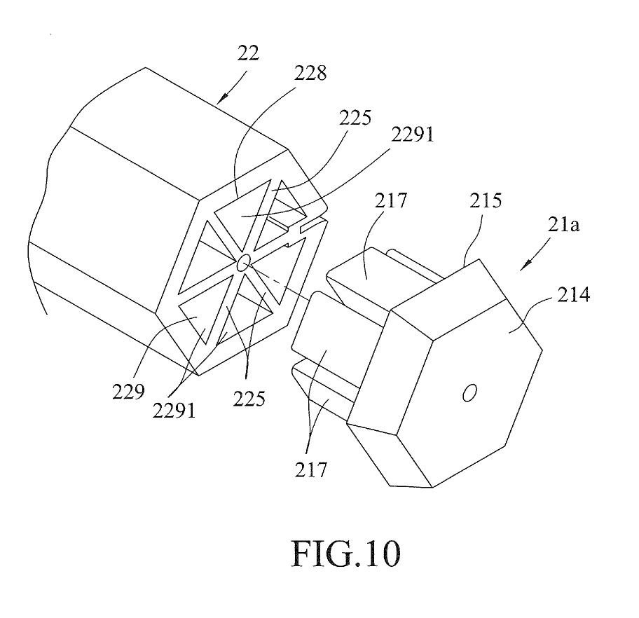

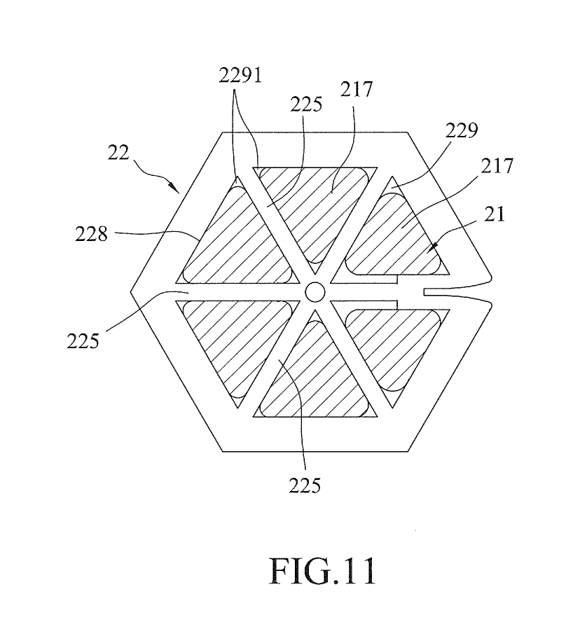

Referring to FIGS. 10 and 11, the fourth preferred embodiment of a lighting apparatus according to the present invention is similar to that of the third preferred embodiment. However, in this embodiment, the end wall portion 21a further has a plurality of angularly spaced-apart insert plates 217 projecting from the second surface 215 into the respective insert channels 2291 of the first tubular portion 22. Each of the insert plates 217 is pressfitted into the respective insert channel 2291 so that the end wall portion 21a is in thermal contact with the first tubular portion 22. Similarly, heat generated by the light-emitting unit 3 can be transferred from the end wall portion 21a to the first tubular portion 22.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A lighting apparatus comprising:
a bulb-shaped cover having an open end and a closed end opposite to said open end, and defining an interior space between said open and closed ends;
a heat sink unit disposed in said interior space and including an end wall portion and a first tubular portion, said end wall portion being disposed in proximity to said closed end of said bulb-shaped cover and having a first surface facing toward said closed end, a second surface opposite to said first surface, and a lateral surface interconnecting said first and second surfaces, said first tubular portion having a first end abutting against said second surface of said end wall portion, and a second end opposite to said first end and proximate to said open end of said bulb-shaped cover;
a light-emitting unit disposed on said heat sink unit and including a first circuit board disposed on said first surface of said end wall portion, a second circuit board disposed around said first tubular portion, a third circuit board including at least one extension corresponding to said lateral surface of said end wall portion, and a plurality of light-emitting elements respectively mounted on said first and second circuit boards and said extension of said third circuit board;
a tubular seat coupled to said open end of said bulb-shaped cover; and
an electrical connector coupled to said tubular seat for connection with an external power source.

2. The lighting apparatus of claim 1, wherein:
said third circuit board further includes a main board disposed between said first surface of said end wall portion and said first circuit board, said extension extending transversely from a periphery of said main board toward said first tubular portion;
said light-emitting unit further includes a fixing plate disposed between said third circuit board and said first circuit board; and
said fixing plate has a base plate covering said main board of said third circuit board, and at least one claw extending transversely from a periphery of said base plate to press said extension of said third circuit board against said lateral surface of said end wall portion.

3. The lighting apparatus of claim 2, wherein said third circuit board is a flexible printed circuit board, and said fixing plate is made of metal.

4. The lighting apparatus of claim 1, wherein said tubular seat includes a trumpet-shaped portion that is made of a plastic material and that is connected to and that surrounds said open end of said bulb-shaped cover, and a tube portion made of a ceramic material and disposed between said trumpet-shaped portion and said electrical connector.

5. The lighting apparatus of claim 4, wherein said trumpet-shaped portion includes a surrounding wall surrounding said open end of said bulb-shaped cover, and a plurality of protrusions protruding from an inner face of said surrounding wall to engage with an outer surface of said bulb-shaped cover in proximity to said open end.

6. The lighting apparatus of claim 1, wherein said heat sink unit further has a shank portion that is connected to and that extends from said second surface of said end wall portion and that is surrounded by said first tubular portion, said first tubular portion and said shank portion defining a heat-dissipating space therebetween.

7. The lighting apparatus of claim 6, wherein said first tubular portion has a polygonal cylinder shape, said second circuit board being a flexible printed circuit board and being bent to extend around an outer surface of said first tubular portion, said light-emitting elements being light-emitting diodes.

8. The lighting apparatus of claim 6, wherein said heat sink unit further has a second tubular portion including an open end section, said second end of said first tubular portion being fitted into said open end section such that at least a part of an outer surface of said first tubular portion is in contact with an inner surface of said second tubular portion.

9. The lighting apparatus of claim 1, wherein said first tubular portion further has an inner periphery defining a receiving space, and a central rod disposed in said receiving space, said second surface of said end wall portion being in contact with said first end of said first tubular portion when said end wall portion is screwed to said central rod of said first tubular portion.

10. The lighting apparatus of claim 9, wherein said first tubular portion further has a plurality of angularly spaced-apart radial plates connected between said inner periphery and said central rod and extending in an axial direction of said first tubular portion to divide said receiving space into a plurality of insert channels, said end wall portion further having a plurality of insert plates projecting from said second surface of said end wall portion into said insert channels, respectively.

11. The lighting apparatus of claim 1, wherein said lateral surface of said end wall portion is flared from a periphery of said first surface toward a periphery of said second surface.
